(19) United States
(12) Patent Application Publication
(10) Pub. No.: US 2014/0372419 A1
(43) Pub. Date: Dec. 18, 2014

(54) TILE-CENTRIC USER INTERFACE FOR QUERY-BASED REPRESENTATIVE CONTENT OF SEARCH RESULT DOCUMENTS

(71) Applicant: Microsoft Corporation, Redmond, WA (US)

(72) Inventors: Yi Li, Issaquah, WA (US); Yu-Ting Kuo, Sammamish, WA (US); Heung-Yeung Shum, Bellevue, WA (US)

(21) Appl. No.: 13/917,347

(22) Filed: Jun. 13, 2013

(51) Int. Cl. G06F 17/30

(52) U.S. Cl. CPC G06F 17/30554
USPC 707/723; 707/722

(57) ABSTRACT

Architecture that represents search results as tiles in a tile-based user interface. The tiles can be images or icons selected to represent a search result or multiple search results. In a broader implementation the tiles can be related to entities as derived from the search results. A web document is received, and on which feature processing is performed to obtain features for each (page, image) tuple. The features are also input to representative image classification, along with the other features to output image classification data. Representative image classification calculates representative scores for every (page, image) pair and (page, image set) pair, and the images are ranked for presentation and viewing in the tile-based user interface. User interaction can be via a touch-based user interface to return and view search results related to a selected tile.

### BACKGROUND

Traditionally, results on search engine result pages (SERPs) are listed in linear order and are presented with text-based snippets. While this has largely worked well in a traditional personal computer desktop context within Internet browser programs, in the new era of touch-based title-centric user interfaces (UIs) this representation is no longer adequate due to the limited dimensions/size and graphically rich nature of the tiles. Additionally, the search results can now be listed in two dimensions (row and column) rather than the linear order; hence, two-dimension presentation introduces additional UI challenges for the average user thereby causing user confusion and a negatively-impacted user experience.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture represents search results as tiles in a tile-based user interface. The tiles can be images or icons selected to represent a search result or multiple search results. In a broader implementation the tiles can be related to entities as derived from the search results.

As applied to computing representative images for search results, as a single example of web document (search result document or page) processing, a web document is received, and on which feature processing is performed to obtain features for each (page, image) tuple. Feature processing includes image processing and page processing. The output of image processing includes image features and image set features. The output of the page processing includes page level features. The image features include, but are not limited to: image size; whether or not the image contains a human head or face; if the image is a photo or a graph; and so on. The page level features include, but are not limited to: the position of the image on the page; whether or not the image is visible before scrolling down the document; whether or not the image is in the main body, header, footer, or side bar of the document; how many similarly sized images appearing above the this image; whether the image title matches the page title; and so on.

An image set is a collection of images that have a logic relationship, such as, all the images appearing in a news story, images appearing in a list of a production, images appearing in a table, etc. Thus, image set features for the tuple (page, image set) are extracted.

Other signals can be used to obtain additional features and improve the classification accuracy, such as how many times an image is shared in social networks, how many documents refer/copy one image, and so on. The image features, image set features, and page level features are input to offline mining.

Offline mining can extract and use the information from more than one page such as how many times one image is used in the same website (to identify domain icons), whether the same DOM (document object model) tree nodes that cross the similar pages consistently refer to a good (or useable) image, and so on. Offline mining can be used detect domain icons and the domain icon can be assigned to every page in that domain. The output of offline mining is other features that can be used for classification processing.

The image features, image set features, and page level features are also input to representative image classification, along with the other features. Representative image classification outputs image classification data. Representative image classification calculates the representative scores for every (page, image) pair and (page, image set) pair. Ranking information is also saved for query dependent representative image selection.

In one implementation, query independent representative image selection can be implemented solely as the technique, in which case, ranking features are not needed. In another implementation, one image per document can be shown. In this case, the representative scores may not be needed and the information for the image set may also not be saved. In yet another implementation, the page type and image type information can be saved. Subsequently, a decision can be computed to show or not show the images based on query and other results.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system for tile-based search result representation in accordance with the disclosed architecture.

FIG. 2 illustrates an alternative embodiment of a system for tile-based search result representation.

FIG. 3 illustrates a high-level architecture for tile-based search result representation when processing documents and associated images.

FIG. 4 illustrates a more detailed diagram of the image classification data.

FIG. 5 illustrates an online system for overall representative image selection and suppression.

FIG. 6 illustrates a system of result grouping for representative images.

FIG. 7 illustrates an exemplary system of tile-based user interface for displaying representative content of search result documents.

FIG. 8 illustrates an alternative tile-based UI.

FIG. 9 illustrates a method in accordance with the disclosed architecture.

FIG. 10 illustrates an alternative method in accordance with the disclosed architecture.

FIG. 11 illustrates a system that finds entities as representative of search results.

FIG. 12 illustrates a block diagram of a computing system that executes representative content for search results in a tile-based user interface in accordance with the disclosed architecture.

### DETAILED DESCRIPTION

The disclosed architecture, in one specific implementation, identifies and associates representative image(s)/thumbnail(s) to web documents to enable a richer snippet experience for the user and support a cleaner, more image-enriched modern-styled search engine result page (SERP) user experience that fits well with tile-based user interface (UI) frameworks to assist the user in readily identifying the results relevant to a search.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

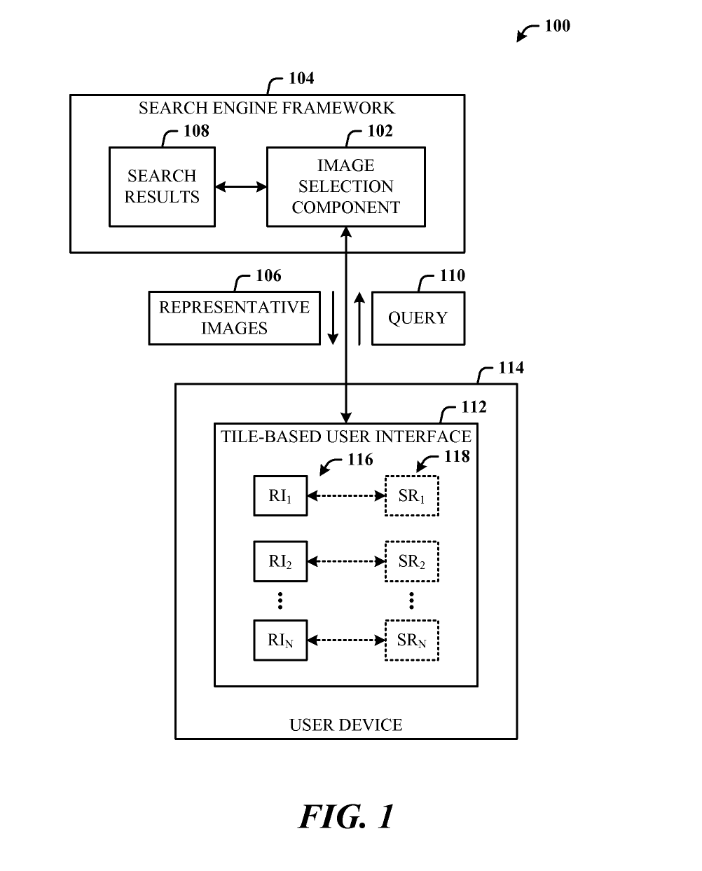

FIG. 1 illustrates a system 100 for tile-based search result representation in accordance with the disclosed architecture. The system 100 can include an image selection component 102 of a search engine framework 104 that selects representative images (RIs) 106 for search results 108 related to a query 110. A tile-based user interface 112 of a user device 114 presents one or more of the representative images 106 as tiles 116 for interactive access of the corresponding search results (SR) 118.

The representative image (e.g., RI₁) for a search result document (e.g., SRI₁) is computed based on a corresponding search result document or source other than the search result document. The representative image of a search result is based on the query. This can be the implicit intent of the query and/or the explicit intent of the query. For example, if the query is “President <name> alma mater” then candidates for such representative images can be the University logo of the President college or university, main entrance (explicit intent) but can be other famous alumni of the University (implicit and/or extended intent).

The representative image of a search result is based on the query, a type of the query, and/or the user context when the query is issued. With respect to context, continuing with the example above, if a user queries “who went to the same college with the President” and then issued the query “President's alma mater” then in this case, the images of other famous alumni can be used as the representative images rather than the school's logo or landmark. In other words, the representative image of a result document can be contextually based (in addition to query based) depending on previous queries, location, type of device, and/or other signals.

The search result of an associated tile is presented in response to a gesture received and interpreted as interacting with the associated tile. The representative image represents content of a group of search results. The representative images correspond to similar results of a single search result document.

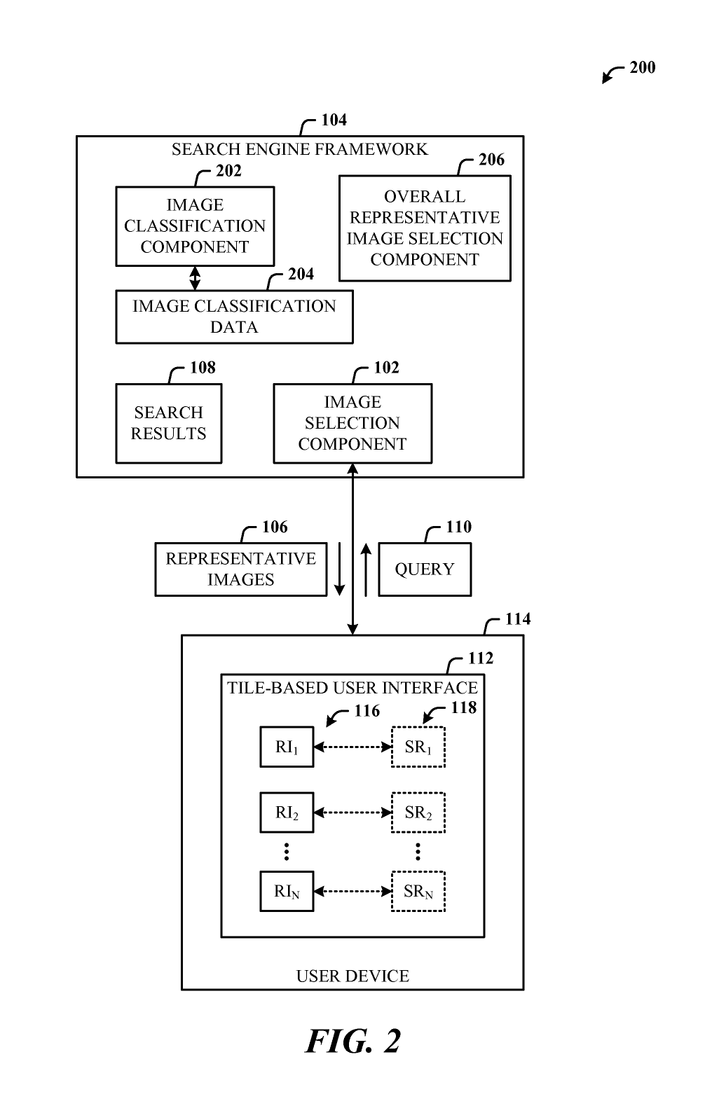

FIG. 2 illustrates an alternative embodiment of a system 200 for tile-based search result representation. The system 200 comprises the items and components of system 100 of FIG. 1, and additionally, an image classification component 202 and an overall representative image selection (-suppression) component 206. The image classification component 202 computes image classification data 204 for a search result (also referred to as a search result document) and the image selection component 102 selects the representative image (e.g., RI₁) for the search result document based on the image classification data 204. The image classification data 204 comprises ranking features and representative scores for images of the search result document. The overall representative image selection component 206 computes a dominant representative image content type of a candidate set of the representative images, or suppresses a minority representative image content type of the representative images.

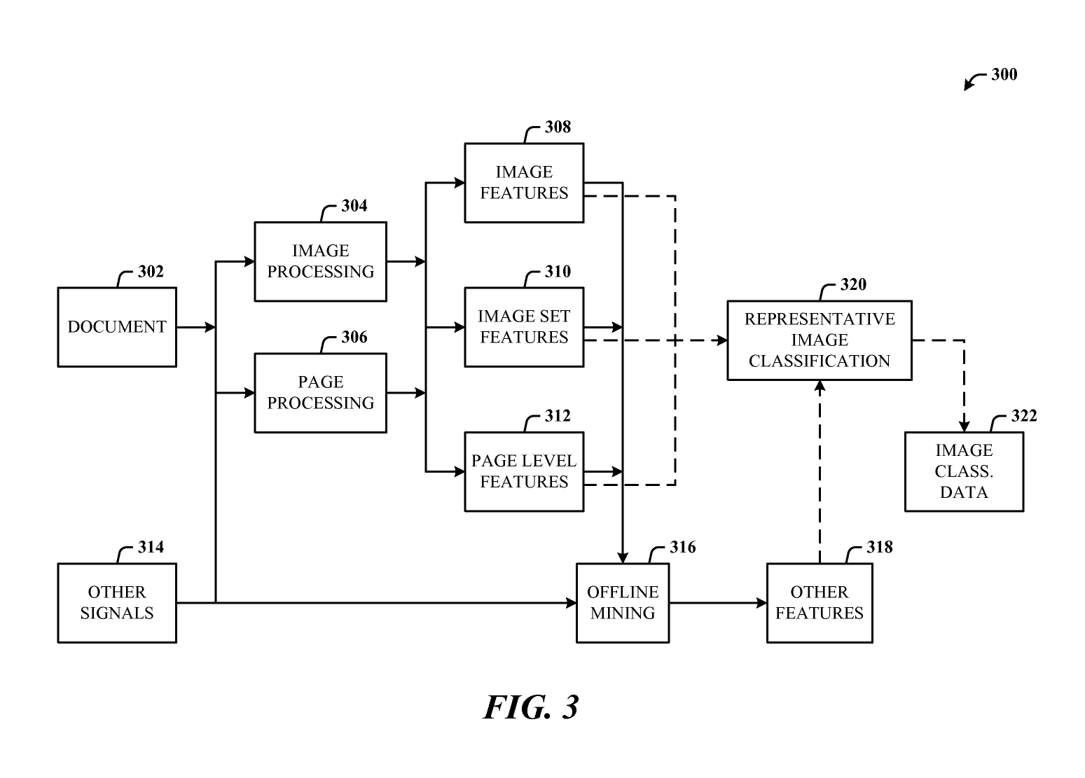

FIG. 3 illustrates a high-level architecture 300 for tile-based search result representation when processing documents and associated images. As a single example of web document (search result document or page) processing, a web document 302 is received, and on which feature processing is performed to obtain features for each (page, image) tuple. Feature processing includes image processing 304 and page processing 306. The output of image processing 304 includes image features 308 and image set features 310. The output of the page processing 306 includes page level features 312.

The image features 308 include, but are not limited to: image size; whether or not the image contains a human head or face; if the image is a photo or a graph; and so on. The page level features 312 include, but are not limited to: the position of the image on the page; whether or not the image is visible before scrolling down the document; whether or not the image is in the main body, header, footer, or side bar of the document; how many similarly sized images appearing above the this image; whether the image title matches the page title; and so on.

An image set is a collection of images that have a logic relationship, such as, all the images appearing in a news story, images appearing in a list of a production, images appearing in a table, etc. Thus, image set features 310 for the tuple (page, image set) are extracted.

Other signals 314 can be used to obtain additional features and improve the classification accuracy, such as how many times an image is shared in social networks, how many documents refer/copy one image, and so on. The image features 308, image set features 310, and page level features 312 are input to offline mining 316.

Offline mining 316 can extract and use the information from more than one page such as how many times one image is used in the same website (to identify domain icons), whether the same DOM (document object model) tree nodes that cross the similar pages consistently refer to a good (or useable) image, and so on. Offline mining 316 can be used detect domain icons and the domain icon can be assigned to every page in that domain. The output of offline mining 316 is other features 318 that can be used for classification processing.

The image features 308, image set features 310, and page level features 312 are also input to representative image classification 320, along with the other features 318. Representative image classification 320 outputs image classification (denoted “class.”) data 322. Representative image classification 320 calculates the representative scores for every (page, image) pair and (page, image set) pair. Ranking information is also saved for query dependent representative image selection.

In one implementation, query independent representative image selection can be implemented solely as the technique, in which case, ranking features are not needed. In another implementation, one image per document can be shown. In this case, the representative scores may not be needed and the information for the image set may also not be saved.

In yet another implementation, the page type and image type information can be saved. Subsequently, a decision can be computed to show or not show the images based on query and other results. For example, if the query is a navigational query, an icon can be shown rather than pictures (images). In another example, if the query is DIY (short for “do-it-yourself”), it may be beneficial to the user to show all related images related rather than a single image.

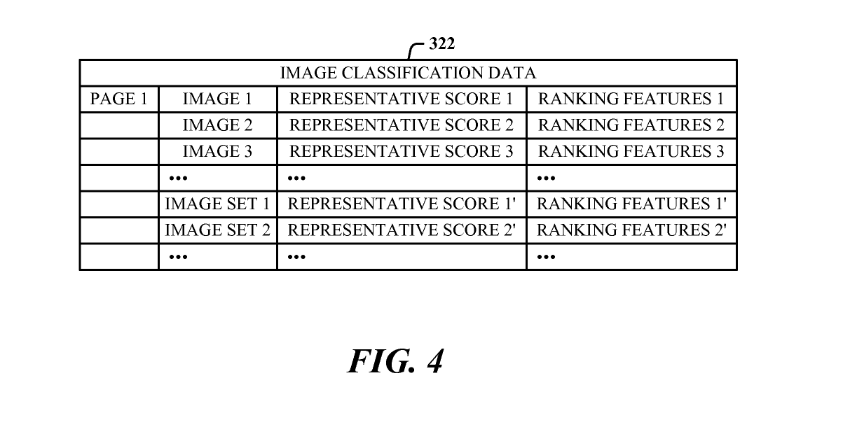

FIG. 4 illustrates a more detailed diagram of the image classification data 322. For a given page (e.g., Page 1) images and image sets can be computed. For example, the page (Page 1) can include a first image (Image 1), a second image (Image 2), and a third image (Image 3), as well as possible other images, having corresponding representative scores (Score 1, Score 2, and Score 3) and corresponding ranking features (Features 1, Features 2, and Features 3). Similarly, the page (Page 1) can include images sets, a first image set (Image Set 1), and a second image set (Image Set 2), as well as possible other image sets, having corresponding representative scores (Score 1′ and Score 2′) and corresponding ranking features (Features 1′ and Features 2′). Thus, the representative image classification 320 outputs this data 322 for online (or runtime) serving.

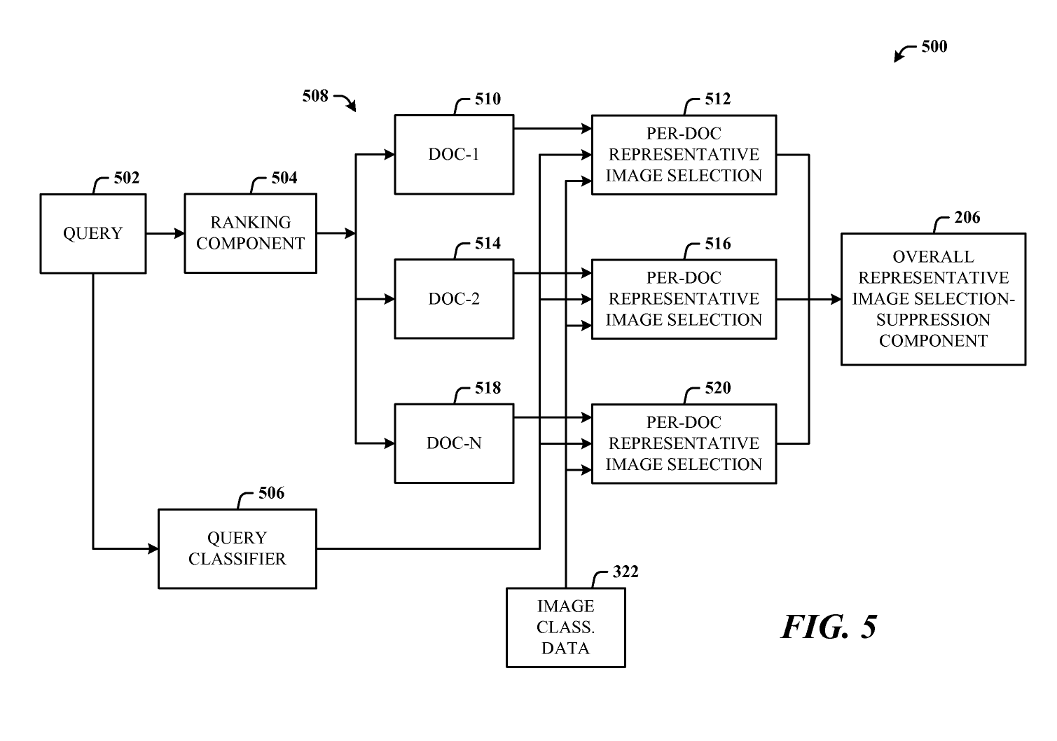

FIG. 5 illustrates an online system 500 for overall representative image selection and suppression. The system 500 illustrates image selection on a per-document basis. In operation, a query 502 is received. The query 502 is input to a ranking component 504 and query classifier 506 for query classification.

Queries can be used for query-dependent representative image selection such as, for a company leadership page, for example, show different executives matching the query. Query type can be used for query-dependent representative image selection such as, if the query is a name query, images with faces are desired, and for navigational queries, site icons can be used.

An output of the ranking component 504 is a set of ranked documents 508 (also denoted Doc-1,Doc-2, . . . ,Doc-N). Features of the ranked documents 508 are then processed for per-document representative image selection. That is, a first ranked document 510 is input for processing to per-document representative image selection 512, a second ranked document 514 is input for processing to per-document representative image selection 516, and an Nth ranked document 518 is input for processing to per-document representative image selection 520. Other inputs to each of the per-document representative image selection components (512, 516, and 520) include the previously-described image classification data 322 and the output of the query classifier 506. The outputs of each of the per-document representative image selection components (512, 516, and 520) are input to the overall representative image selection (-suppression) component 206.

The overall representative image selection-suppression component 206 can be used to improve selection precision and/or improve presentation consistency. For example, if at least a majority (or some threshold number) of the results return a face image (e.g., solely a face or includes a face, which may indicate the query is people oriented), the results can be adjusted from the other pages to return face images as well. If at least a majority (or some threshold number) of the results return images instead of icons, icons can be suppressed from the other pages. If less than a minimum number of pages return images, it can be determined to not show images at all.

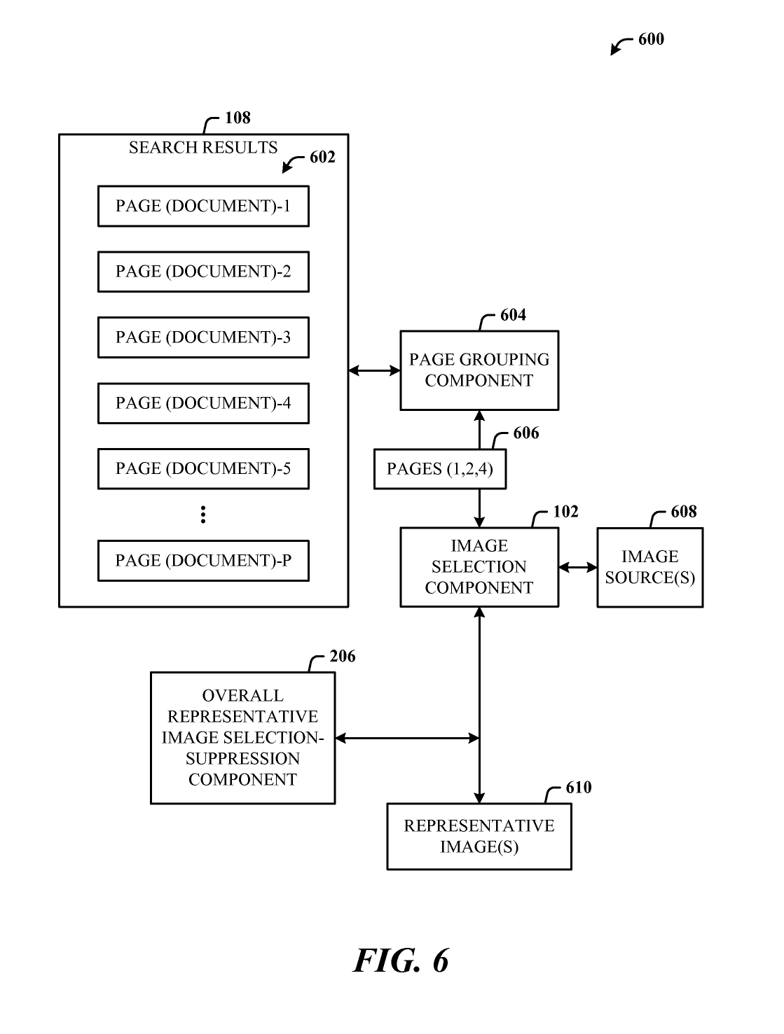

FIG. 6 illustrates a system 600 of result grouping for representative images. Page results 602 can be grouped based on the content, and then one or more images selected to represent the group. Accordingly, the results 602 are passed to a page grouping component 604, which in this example, groups result pages 606: Page-1, Page-2, and Page-4 as related based on some grouping criteria (e.g., entity, content, content type, query, etc.). Image selection for these three result pages 606 can be performed by the image selection component 102 based on image sources 608 such as the pages 606 themselves and/or sources unrelated to the content and/or pages 606. The output of the image selection component 102 is then the one or more representative images 610 for the result pages 606.

Alternatively, the output of the image selection component 102 is processed through the overall representative image selection-suppression component 206 for yet further processing to ultimately output the one or more representative images 610.

It can be the case to show more than one representative image for a single page (document). For example, if the query is related to looking for shoes and the result page contains a list of shoes, it can be computed to show the images for each of the results for shoes on that given page. When a page contains one or more images, in most cases the representative image can be one of those images; however, representative images do not need to be derived come from the page.

In another implementation, images not even from the page need not be selected, but in most cases, such off-page images are used to illustrate the content type, page information, and etc. For example, a site icon can be used for pages from the associated website to help the user identify the source of the page. Additionally, images corresponding to the entities detected from the pages can be used. For example, a pop star image for a page can be shown as representative even though that page does not contain images. Moreover, images can be used to illustrate the page type, such as a news icon to indicate a news page, for example.

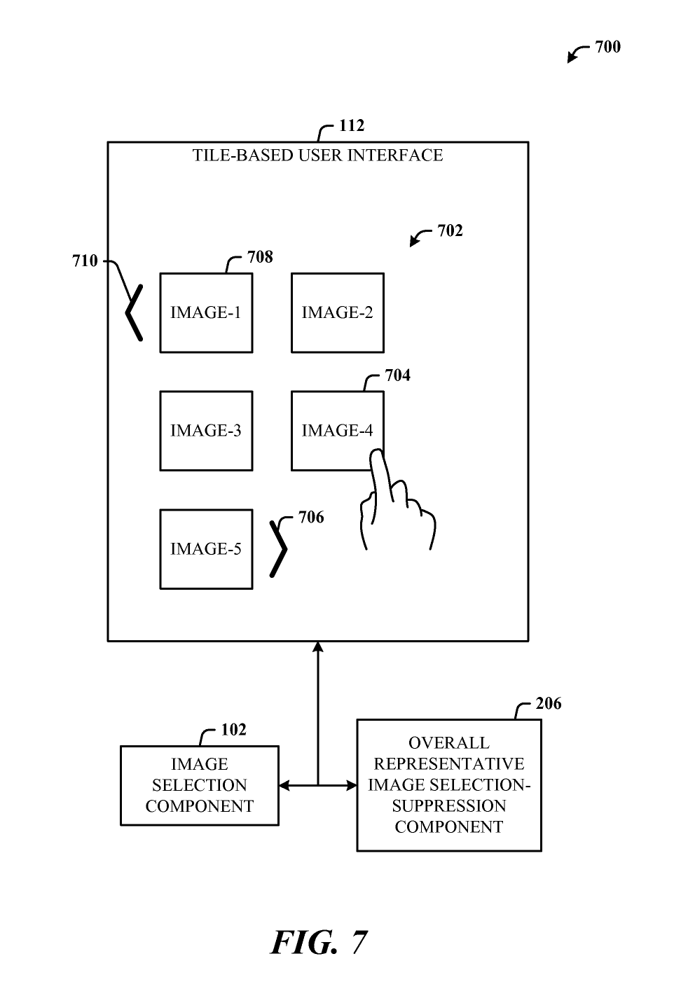

FIG. 7 illustrates an exemplary system 700 of tile-based user interface 112 for displaying representative content of search result documents. Here, five images (Image-1, Image-2, Image-3, Image-4, and Image-5) have been selected by the image selection component 102 and/or the overall representative image selection-suppression component 206 for presentation as tiles 702. The images (and image tiles 702) can be representative of five corresponding result pages. As described above for result grouping, a single image (e.g., Image-2) of the image tiles 702 can be representative of more than one result page. Still further, multiple images (e.g., Image-1 and Image-3) of the image tiles 702 can be selected to be representative of a single result page.

The UI 112 can facilitate the presentation of the image tiles 702 (and, hence, images) in a ranked manner so the user can readily perceive the ranking for the desired result selection. Although the use of images (and image tiles 702) enhances the ability of the user to readily see and understand the results, UI ranking can further be employed. In this example, the five images (and image tiles 702) can be ranked in a top-down, left-to-right fashion, which is also understood or configured by the user, so the user knows the visual ranking technique of the image tiles 702. Thus, Image-1 is ranked the highest of the five visible image tiles 702, and Image-5 is ranked the lowest of the five visible image tiles 702.

It can be the case that the user chooses the ranking from left-to-right and then down to the next row, as in reading English text. However, it is to be understood that the tile-based image representation for results can be configured by the user for presentation in any desired manner to make result understanding more intuitive according to the country or style of user perception (e.g., reading) desired.

It can be the case that the user chooses to see only the top five results, in which case five tiles are shown. However, as described herein, if not on a per-document basis, there can be fewer or more images (and hence, tiles) shown.

As with the desire/request at times for user feedback by the search engine or other systems, the user can choose to re-rank the results by re-orienting the associated result tiles in a desired way. The tile manipulation can be performed by a tile drag-and-drop operation (e.g., touch-based), for example. The noted new position of the tile or tiles is then processed by user device software to then feedback this re-ranking information to the desired systems such as search engine model development and updating.

If the user chooses to view the content associated with the fourth tile image, Image-4, the user can interact with the fourth tile 704, in response to which the associated search result (or results) is (are) displayed. As previously indicated, an icon can be presented, thus the tile associated with Image-5 can be an icon.

Alternatively, the user device can be configured to show a maximum number of tiles and then indicate to the user via a right-pointing list navigation object 706 (e.g., a chevron) that other tiles can be viewed. The user can then touch (select) the object 706 to view more tiles out of view to the right and ranked lower than then the result(s) associated therewith. This then pushes the first tile 708 (for Image-1) out of view (given that only five search result tiles may be shown at any one time for this device—this number can be adjusted up or down for the device (display) being used), and then presents a left-pointing navigation object 710 to indicate that other tiles (the Image-1 tile) are out of view, and can be accessed.

The user interface architecture can employ natural user interface (NUI) techniques. NUI may be defined as any interface technology that enables a user to interact with a device in a “natural” manner, free from artificial constraints imposed by input devices such as mice, keyboards, remote controls, and the like. Examples of NUI methods include those methods that employ gestures, broadly defined herein to include, but not limited to, speech recognition, touch recognition, stylus recognition, gesture recognition both on screen and adjacent to the screen, air gestures, head and eye tracking, voice and speech utterances, and machine learning related at least to vision, speech, voice, pose, and touch data.

NUI technologies include, but are not limited to, touch sensitive displays, voice and speech recognition, intention and goal understanding, motion gesture detection using depth cameras (e.g., stereoscopic camera systems, infrared camera systems, color camera systems, and combinations thereof), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (e.g., electro-encephalograph (EEG)) and other neuro-biofeedback methods.

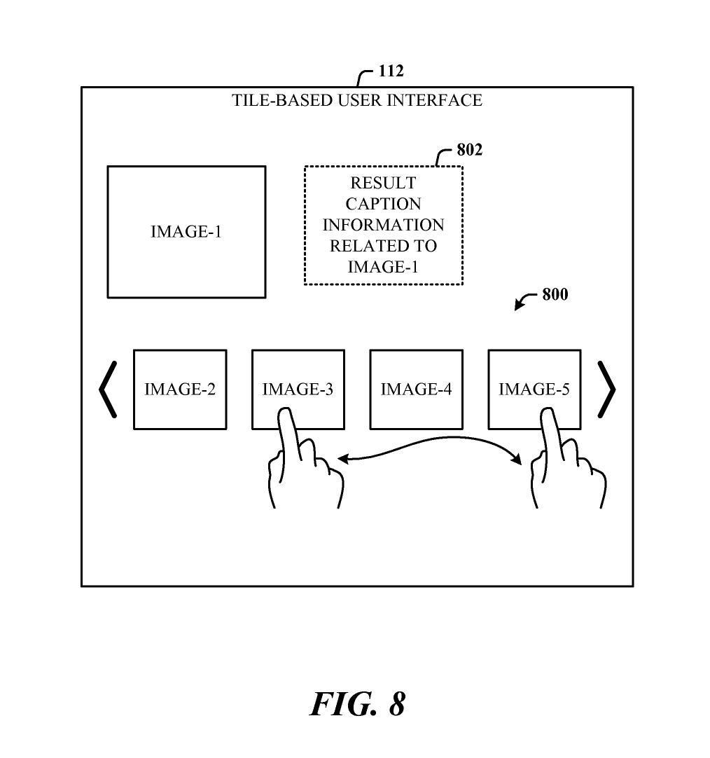

FIG. 8 illustrates an alternative tile-based UI 112. Here, the UI 112 is touch-based, and the result tiles 800 (Image-1, Image-2, Image-3, Image-4, and Image-5) are left and right (touch) scrollable along the bottom of the display (or viewport), and the selected tile (Image-1) is expanded above the tile row along with a more detailed set of content 802 (e.g., result caption information related to Image-1). The caption information can include all the media associated with a search results, such as title, image, link, short snippet of text about the related page, and so on. In this implementation, rather than using a mouse-over hover that interacts with pop-up content for a given image, the UI 112 can enable gesture-over interaction, where the non-contact placement of a user hand over a display object (or visual element) causes interaction (e.g., selection) with the object, such as a result tile. The gesture-over can also initiate an audio response associated with a specific tile, which plays audio information about the search result(s) for that tile (image). Other types of media can be associated and presented as desired. For example, a pop-up window can briefly appear as the user gesture-overs a specific tile, to give a brief summary of the associated search result.

The result tiles 800 (and results) can be ranked from the higher popular/relevant ranked results left of the lower ranked results. A similar presentation can be a vertically ranked set of tiles (and results) rather than the row-based ranked set of tiles shown.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

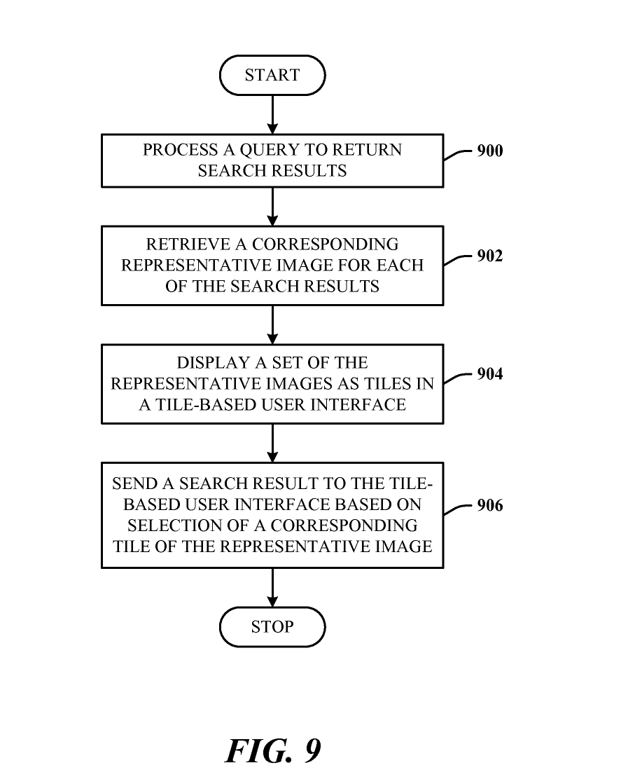

FIG. 9 illustrates a method in accordance with the disclosed architecture. At 900, a query is processed to return search results. At 902, a corresponding representative image is retrieved for each of the search results. The image can be obtained from a search result page, or an unrelated source(s), and alternatively, can be an icon or be of an icon. At 904, a set of the representative images is displayed as tiles in a tile-based user interface. The representative images can be processed into tiles of a predetermined dimension suitable for a given display on which it is presented. At 906, a search result is sent to the tile-based user interface based on selection of a corresponding tile of the representative image. The search engine responds with the search result or results associated with the specifically selected tile.

The method can further comprise selecting the representative image based on the query (a query dependent representative image selection), type of query (e.g., if a name query, consider face images, and if related to navigations purposes, select an icon), or the user context when the query is issued.

The method can further comprise classifying representative images of a document associated with a search result based on image features (e.g., image size, image content, photo or a graph, etc.) of the document, image set features (features common to multiple images) of the document, and document-level features (e.g., position of image on the page, if image is visible without scrolling, image title matches or closely matches the page title, etc.).

The method can further comprise retrieving and presenting multiple representative images as tiles for a given search result. For example, if the query relates to shoes, and the associate search result page includes multiple images of different shoes, some or all of the page images can be selected as the representative images and displayed in the tile-based UI.

The method can further comprise grouping search results based on content and presenting one or more representative images as tiles for the group of search results. If the search results are computed to be closely related, a single representative image can be selected for his group. Accordingly, once the associated tile is selected, the group of results is returned for presentation.

The method can further comprise deriving the representative image from a source other than a document associated with the search result. It can be the case that the search result page does not include an image, in which case, based on analysis of the page content, the representative image can be selected from another source. This is referred to as query independent representative image selection.

The method can further comprise displaying the set of representative images in the tile-based user interface in a ranked manner according to ranking of the corresponding search results. The method can further comprise selecting an overall representative image based on query intent inferred from image features obtained from of a majority of images associated with the search results. For example, if most of the results return a face image, this may indicate or be used to infer the query relates to people. Thus, the results of other pages can be adjusted to be biased to returning face images as well.

It can be the case that should the user input similar queries (search for similar) over time, the disclosed architecture may return the same representative image(s) as in a previous search session to quickly convey to the user the similar search results. This is a query independent process since image processing may not be performed on the result pages, but a same representative image is returned as used in a previous session the user may recall was related to previous results.

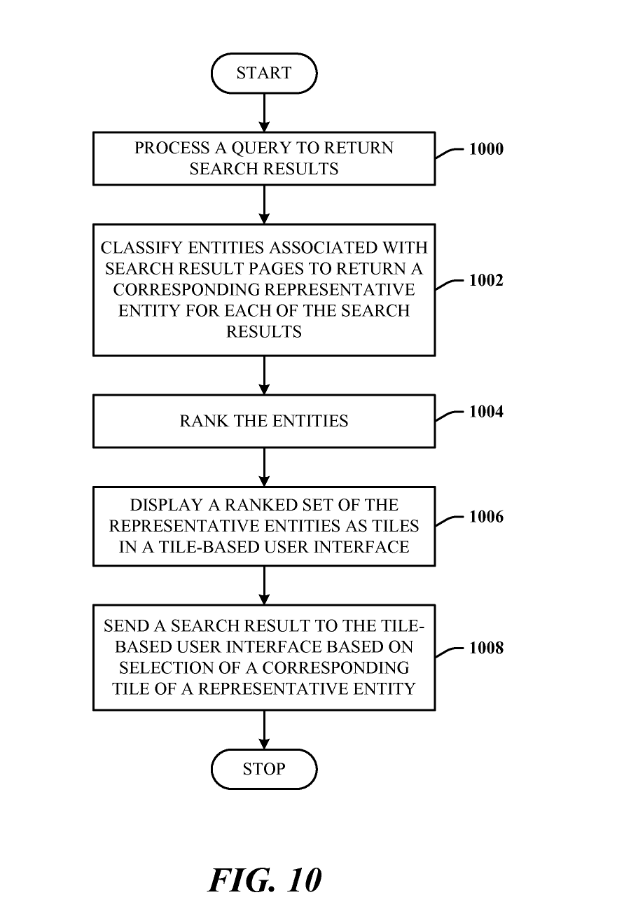

FIG. 10 illustrates an alternative method in accordance with the disclosed architecture. At 1000, a query is processed to return search results. At 1002, entities associated with search result pages are classified to return a corresponding representative entity for each of the search results. An entity has a distinct, separate existence, such as a person, movie, restaurant, event, book, song, place of interest, etc. Each entity has a name and associated attributes. As described herein, an image is an entity; thus, the description herein in terms of images, applies to the broader aspect of an entity as well.

At 1004, the entities are ranked. At 1006, a ranked set of the representative entities is displayed as tiles in a tile-based user interface. At 1008, a search result is sent to the tile-based user interface based on selection of a corresponding tile of a representative entity. Representative scores are computed for each page-entity tuple and each page-entity set tuple for ranking the entities. The search result of an associated tile is presented in response to a gesture (e.g., touch, gesture-over, received gesture interpreted as a selection operation, etc.) received and interpreted as interacting with the associated tile.

In a similar operation, querying for an image or picture of a person or scene can result in finding a candidate set of images, selecting a desired image from the candidate set, computing features of the selected image, and then returning search results based on the image features of the selected image. For example, if the query is “picture of Mozart”, as a backend process a set of ranked results can be found, images selected, and related search results presented as tiles such as a Mozart Music tile, a Mozart Bio tile, a Mozart History tile, etc.

Where a single image (representative or not) relates to two or more different result documents, it can be inferred that the result documents are related (relevant) as well. This can be determined based on image feature comparison of various candidate images obtained from the search result documents.

It can be the case as well, where the results served to other users who input the same search, influence the results served to a current user inputting the same query.

In another embodiment, the characteristics or prior behavior of a user can be used to infer what the user may want to see on the current search. For example, if the user tends to want to see people images rather than building images, as evidenced in past search sessions, people images will likely be served during the current search session.

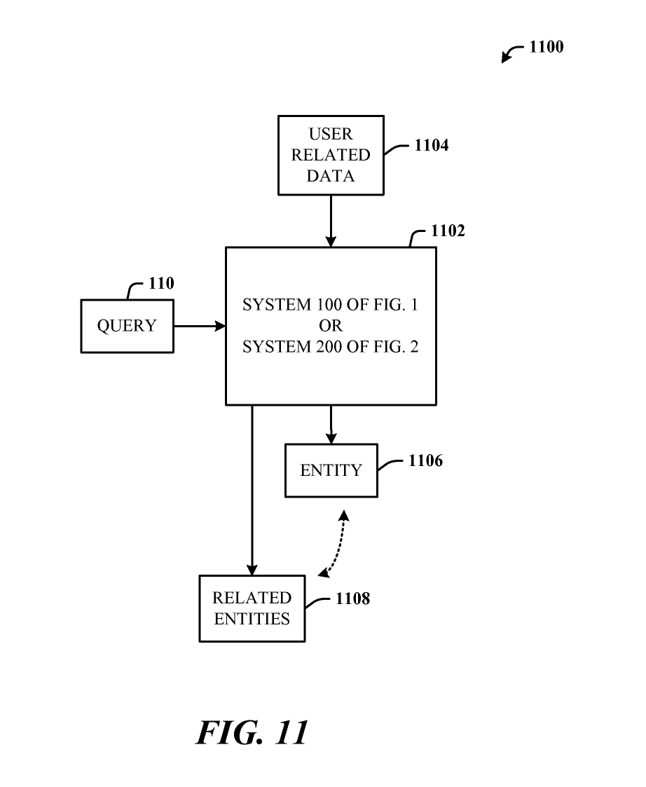

FIG. 11 illustrates a system 1100 that finds entities as representative of search results. The central components 1102 include at least the system 100 of FIG. 1 or the system 200 of FIG. 2. User related data 1104 comprises all information about the user such as user location, user preferences, user profile information, time of day, day of the week, environmental conditions, etc., that can be obtained and processed to provide more relevant search results and entities (e.g., images). Thus, an entity 1106 can be derived as well as related entities 1108 that can be employed to represent search results in a tile-centric user interface.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

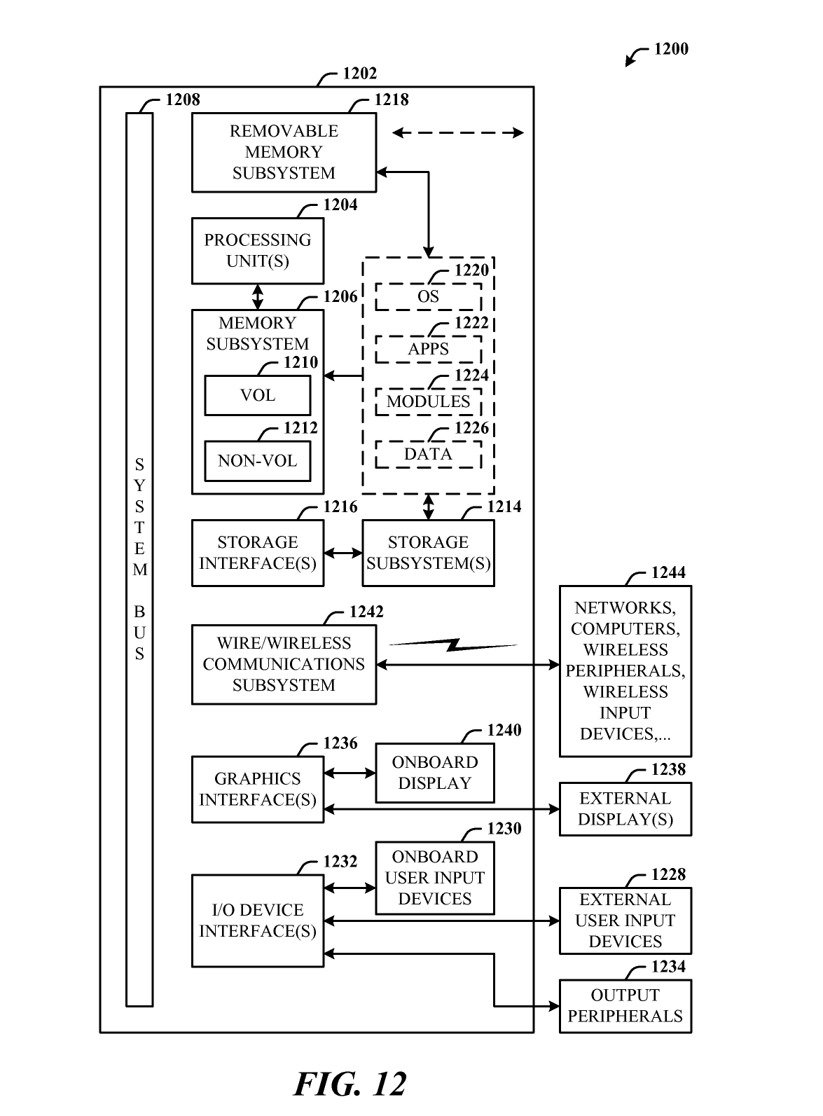

Referring now to FIG. 12, there is illustrated a block diagram of a computing system 1200 that executes representative content for search results in a tile-based user interface in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 12 and the following description are intended to provide a brief, general description of the suitable computing system 1200 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1200 for implementing various aspects includes the computer 1202 having processing unit(s) 1204 (also referred to as microprocessor(s) and processor(s)), a computer-readable storage medium such as a system memory 1206 (computer readable storage medium/media also include magnetic disks, optical disks, solid state drives, external memory systems, and flash memory drives), and a system bus 1208. The processing unit(s) 1204 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 1202 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 1206 can include computer-readable storage (physical storage) medium such as a volatile (VOL) memory 1210 (e.g., random access memory (RAM)) and a non-volatile memory (NON-VOL) 1212 (e.g., ROM, EPROM, EEPROM, etc.). A basic input/output system (BIOS) can be stored in the non-volatile memory 1212, and includes the basic routines that facilitate the communication of data and signals between components within the computer 1202, such as during startup. The volatile memory 1210 can also include a high-speed RAM such as static RAM for caching data.

The system bus 1208 provides an interface for system components including, but not limited to, the system memory 1206 to the processing unit(s) 1204. The system bus 1208 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1202 further includes machine readable storage subsystem(s) 1214 and storage interface(s) 1216 for interfacing the storage subsystem(s) 1214 to the system bus 1208 and other desired computer components. The storage subsystem(s) 1214 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 1216 can include interface technologies such as EIDE, ATA, SATA, and IEEE 1394, for example.

One or more programs and data can be stored in the memory subsystem 1206, a machine readable and removable memory subsystem 1218 (e.g., flash drive form factor technology), and/or the storage subsystem(s) 1214 (e.g., optical, magnetic, solid state), including an operating system 1220, one or more application programs 1222, other program modules 1224, and program data 1226.

The operating system 1220, one or more application programs 1222, other program modules 1224, and/or program data 1226 can include items and components of the system 100 of FIG. 1, items and components of the system 200 of FIG. 2, the high-level architecture 300 of FIG. 3, the image classification data 322 of FIG. 4, items and components of the system 500 of FIG. 5, items and components of the system 600 of FIG. 6, items and components of the system 700 of FIG. 7, items and components of the alternative tile-based UI 112 of FIG. 8, the methods represented by the flowcharts of FIGS. 9 and 10, and items and components of the system 1100 of FIG. 11, for example.

Generally, programs include routines, methods, data structures, other software components, etc., that perform particular tasks or implement particular abstract data types. All or portions of the operating system 1220, applications 1222, modules 1224, and/or data 1226 can also be cached in memory such as the volatile memory 1210, for example. It is to be appreciated that the disclosed architecture can be implemented with various commercially available operating systems or combinations of operating systems (e.g., as virtual machines).

The storage subsystem(s) 1214 and memory subsystems (1206 and 1218) serve as computer readable media for volatile and non-volatile storage of data, data structures, computer-executable instructions, and so forth. Such instructions, when executed by a computer or other machine, can cause the computer or other machine to perform one or more acts of a method. Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 1202, and include volatile and non-volatile internal and/or external media that is removable and/or non-removable. For the computer 1202, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 1202, programs, and data using external user input devices 1228 such as a keyboard and a mouse, as well as by voice commands facilitated by speech recognition. Other external user input devices 1228 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1202, programs, and data using onboard user input devices 1230 such a touchpad, microphone, keyboard, etc., where the computer 1202 is a portable computer, for example.

These and other input devices are connected to the processing unit(s) 1204 through input/output (I/O) device interface(s) 1232 via the system bus 1208, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1232 also facilitate the use of output peripherals 1234 such as printers, audio devices, camera devices, and so on, such as a sound card and/or onboard audio processing capability.

One or more graphics interface(s) 1236 (also commonly referred to as a graphics processing unit (GPU)) provide graphics and video signals between the computer 1202 and external display(s) 1238 (e.g., LCD, plasma) and/or onboard displays 1240 (e.g., for portable computer). The graphics interface(s) 1236 can also be manufactured as part of the computer system board.

The computer 1202 can operate in a networked environment (e.g., IP-based) using logical connections via a wired/wireless communications subsystem 1242 to one or more networks and/or other computers. The other computers can include workstations, servers, routers, personal computers, microprocessor-based entertainment appliances, peer devices or other common network nodes, and typically include many or all of the elements described relative to the computer 1202. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1202 connects to the network via a wired/wireless communication subsystem 1242 (e.g., a network interface adapter, onboard transceiver subsystem, etc.) to communicate with wired/wireless networks, wired/wireless printers, wired/wireless input devices 1244, and so on. The computer 1202 can include a modem or other means for establishing communications over the network. In a networked environment, programs and data relative to the computer 1202 can be stored in the remote memory/storage device, as is associated with a distributed system. It will be appreciated that the network connections shown are exemplary and other means of establishing a communications link between the computers can be used.

The computer 1202 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an image selection component that selects representative images for search results related to a query;
a tile-based user interface that presents one or more of the representative images as tiles for interactive access of the corresponding search results; and
a microprocessor that executes computer-executable instructions associated with the image selection component.

2. The system of claim 1, wherein the representative image for a search result document is computed based on a corresponding search result document or a source other than the search result document.

3. The system of claim 1, wherein the representative image of a search result is based on the query, the type of the query, or user context when the query is issued.

4. The system of claim 1, wherein the search result of an associated tile is presented in response to a gesture received and interpreted as interacting with the associated tile.

5. The system of claim 1, wherein the representative image represents content of a group of search results.

6. The system of claim 1, wherein the representative images correspond to similar results of a single search result document.

7. The system of claim 1, further comprising an image classification component that computes image classification data for a search result document and the image selection component selects the representative image for the search result document based on the image classification data.

8. The system of claim 7, wherein the image classification data comprises ranking features and representative scores for images of the search result document.

9. The system of claim 1, further comprising an overall representative image selection component that computes a dominant representative image content type of a candidate set the representative images, or suppresses a minority representative image type of the representative images.

10. A method, comprising acts of:
processing a query to return search results;
retrieving a corresponding representative image for each of the search results;
displaying a set of the representative images as tiles in a tile-based user interface; and
sending a search result to the tile-based user interface based on selection of a corresponding tile of the representative image.

11. The method of claim 10, further comprising selecting the representative image based on the query, type of query, or user context when the query is issued.

12. The method of claim 10, further comprising classifying representative images of a document associated with a search result based on image features of the document, image set features of the document, and document-level features.

13. The method of claim 10, further comprising retrieving and presenting multiple representative images as tiles for a given search result.

14. The method of claim 10, further comprising grouping search results based on content and presenting one or more representative images as tiles for the group of search results.

15. The method of claim 10, further comprising deriving the representative image from a source other than a document associated with the search result.

16. The method of claim 10, further comprising displaying the set of representative images in the tile-based user interface in a ranked manner according to ranking of the corresponding search results.

17. The method of claim 10, further comprising selecting an overall representative image based on query intent inferred from image features obtained from of a majority of images associated with the search results.

18. A computer-readable medium comprising computer-executable instructions that when executed by a processor, cause the processor to perform acts of:
processing a query to return search results;
classifying entities associated with search result pages to return a corresponding representative entity for each of the search results;
ranking the entities;
displaying a ranked set of the representative entities as tiles in a tile-based user interface; and
sending a search result to the tile-based user interface based on selection of a corresponding tile of a representative entity.

19. The computer-readable medium of claim 18, further comprising computing representative scores for each page-entity tuple and each page-entity set tuple for ranking the entities.

20. The computer-readable medium of claim 18, further comprising presenting the search result of an associated tile in response to a gesture received and interpreted as interacting with the associated tile.
